(19) United States
(12) Patent Application Publication
(10) Pub. No.: US 2012/0274462 A1
(43) Pub. Date: Nov. 1, 2012

(54) Signaling device with "stop" and "position" functions using a light guide and generating a 3D effect

(75) Inventors: Juan Manuel Martinez, Granada (ES); Alexandre Chotard, Martos (ES); Jesus Romo, Martos (ES); Miguel Angel Jimenez Villar, Martos (ES); Eric Moisy, Jaen (ES); Jesus Lopez Centeno, Martos (ES)

(73) Assignee: VALEO VISION, Bobigny Cedex (FR)

(21) Appl. No.: 13/455,302

(22) Filed: Apr. 25, 2012

(30) Foreign Application Priority Data
Apr. 29, 2011 (FR) 1153699

(51) Int. Cl. B60Q 1/44; B60Q 1/48

(52) U.S. Cl. 340/479

(57) ABSTRACT

A luminous signaling module, notably for automobile vehicles, comprising: a reflector; a screen disposed in front of the reflector, with a semi-reflecting area; radiating means adapted to emit light rays. The reflector, the screen and the radiating means being arranged in such a manner as to generate a repetitive visual effect of depth. The semi-reflecting area is configured and arranged relative to the radiating means in such a manner that a second portion of the light rays emitted by radiating means do not encounter the semi-transparent area.

### CROSS-REFERENCE TO RELATED APPLICATIONS

This application claims priority to French Application No. 1153699 filed Apr. 29, 2011, which application is incorporated herein by reference and made a part hereof.

### BACKGROUND OF THE INVENTION

1. Field of the Invention

The invention relates to a luminous signaling module, notably for automobile vehicles. The invention relates more particularly to a signaling module of the “position” (or “parking light”) type and/or of the “stop” light type for vehicles. The invention relates even more particularly to a signaling device generating an effect of depth in three dimensions thanks to a particular optical device. The invention also relates to a signaling device including such a module.

2. Description of the Related Art

The patent document EP 1 916 471 A1, which is equivalent to U.S. Patent Publication 2008/0094842 which is incorporated herein by reference and made a part hereof, describes a rear light of the “parking light” type including a cavity formed by a reflector and a screen disposed at a distance from the reflector. The screen has the particular feature of being semi-transparent, i.e. some of the light rays encountering it are reflected and others are transmitted. The cavity has the particular feature that one of the surfaces of the reflector and of the screen that delimit the cavity is domed. A series of light sources of the light-emitting diode type is disposed at the periphery of the reflector and oriented so as to emit light generally toward the screen. Given the semi-transparent nature of the latter, some of the light rays are transmitted directly and some are reflected toward the reflector. The latter then reflects these rays toward the screen with an offset directed toward the center of the reflector. These rays reflected by the reflector encounter the screen again. In a similar way to the light rays coming directly from the light sources, some of the rays are transmitted by the screen and some are reflected toward the reflector, and so on. The result of these multiple partial transmissions and partial reflections is an optical effect of depth in three dimensions. The lighting or illumination power of the light rays emitted decreases progressively as they are reflected in the cavity. This optical effect is of interest because it enables personalization of the “parking light” attracting the attention of other motorists. It also enables the dissimulation of the “parking light” in a bodywork element, such as an automobile vehicle fender or bumper. It also enables the production of a signaling device that is thin and of small overall size in relation to the depth effect generated. The semi-transparent nature of the screen is obtained by the application of a metallic coating which may give it a metalized appearance similar to that of a bodywork element. The teaching of the above document nevertheless has a major drawback, namely the treatment of the screen intended to render it semi-transparent. The metallic layer applied to the screen will have the consequence that more than 4% of the light is reflected into the cavity and that less than 96% of the rays coming from the light sources will be transmitted (this is without counting the losses inherent to the material of the screen). The level of reflection and transmission may vary and will be directly dependent on the application of the metallic layer. From a process point of view, it is very difficult to guarantee reflection and transmission factors in a narrow tolerance range. The consequence of this is that in the absence of a costly method of treating the screen, the “parking light” equipped with a light source of standard power runs the risk of not satisfying the photometric conditions required by the legislation for a signaling function and also the risk of generating a difference in appearance between the left-hand and right-hand parking lights of the vehicle. For these reasons, this construction is even less suited to a “stop” type function requiring from a photometric point of view a significantly higher lighting power. Moreover, the construction is relatively constraining from the point of view of the number of light sources necessary and also the shape of the light. It is suited to compact shapes as opposed to elongate shapes that would otherwise require too great a number of light sources.

### SUMMARY OF THE INVENTION

An objective of the invention is to propose a signaling module alleviating at least some of the drawbacks referred to above. The invention has the more particular objective proposing a signaling module that is of relatively low cost to produce, notably assuring sufficient photometry for a “stop” function and/or allowing some freedom of shape, notably elongate shapes.

The invention provides a luminous signaling module, notably for automobile vehicles, comprising a reflector with a reflecting surface; a screen disposed in front of the reflector, the screen comprising a semi-reflecting area; radiating means adapted to emit light rays, the reflector, the screen and the radiating means being arranged in such a manner that a first portion of the rays emitted by the radiating means encounters the semi-reflecting area, some of the rays of this first portion being transmitted directly through the semi-reflecting area, other rays of this first portion being reflected by the semi-reflecting area toward the reflector that sends them back again toward the semi-reflecting area, in such a manner as to generate a repetitive visual effect of depth; the module is noteworthy in that the semi-reflecting area is configured and arranged relative to the radiating means in such a manner that a second portion of the light rays emitted by the radiating means does not encounter the semi-transparent area.

The semi-reflecting layer is such that, on the one hand, some of the rays encountering it are subjected at least once to the chaining of reflections comprising a reflection by the semi-reflecting area, then a reflection by the reflector to reach the reflecting area gain, and, on the other hand, some of the rays encountering it are transmitted through the screen. Some rays may be subjected to this chaining several times. In this case the 3D effect will be reinforced.

The second portion light rays preferably passes beside the semi-transparent area.

The radiating means are adapted to emit light.

The first and/or second portion of the light rays emitted by the radiating means preferably correspond to at least 30%, even 40%, of the light rays emitted.

In an advantageous embodiment of the invention, the screen forms with the reflector a space in which the reflected rays are propagated, this space being delimited by a surface of the screen and a reflecting surface of the reflector, at least one of these surfaces being such that the rays reflected by the semi-reflecting area from a first location of this area encounter this area again, after reflection at the reflector, at a second location distinct from the first location.

In an advantageous embodiment of the invention, the screen forms with the reflector a space in which the reflected rays are propagated, this space being delimited by a surface of the screen and a reflecting surface of the reflector, at least one of these surfaces being domed. This is an embodiment that is simple to produce and enables the 3D effect to be enhanced.

The screen is preferably disposed at a distance from the reflector.

In another advantageous embodiment of the invention, the radiating means comprise a light source and at least one element for diverting rays emitted by the light source.

In a further advantageous embodiment of the invention, the deviation element comprises at least one light guide, preferably a longitudinal light guide.

In a further advantageous embodiment of the invention, the light guide is configured to reflect generally transversely to its longitudinal axis light rays traveling through the guide in such a manner as to form the light rays emitted by the radiating means.

In a further advantageous embodiment of the invention, the light guide is of generally circular section.

In a further advantageous embodiment of the invention, the light guide is disposed so that its longitudinal axis is generally parallel to the screen and/or to the reflector.

In a further advantageous embodiment of the invention, the light guide is disposed along an edge of the reflector.

In a further advantageous embodiment of the invention, the radiating means are configured so that the light guide is fed with light exclusively at one at least of its ends.

In a further advantageous embodiment of the invention, the light guide comprises on its exterior surface, preferably on a portion that is opposite the screen, a first row of reflecting facets adapted to reflect generally transversely in a first direction. The first direction is for example perpendicular to the longitudinal axis of the guide in which the light rays travel.

In a further advantageous embodiment of the invention, the radiating means emit light rays in only one main direction and the semi-transparent area of the screen is disposed in such a manner that one of its edges is the frontier between the first portion and the second portion of the light rays.

In a further advantageous embodiment of the invention, the light guide comprises on its exterior surface a second row of reflecting facets adapted to reflect light trays traveling through it in a second direction inclined relative to the first direction in such a manner that the rays emitted are directed toward the semi-transparent area. The reflecting facets are preferably adapted to reflect light rays traveling in it generally transversely to the longitudinal axis of the guide. In an advantageous variant, the emitted rays are preferably for the most part directed toward the semi-transparent area.

In a further advantageous embodiment of the invention, the second row of reflecting facets is disposed generally parallel to the first row.

In a further advantageous embodiment of the invention, the radiating means comprise two light guides, for example longitudinal light guides, configured to reflect light rays traveling through them in such a manner as to form two beams of parallel light rays in a main illumination direction. In the situation where these guides are longitudinal, they may transmit these rays generally transversely to their longitudinal axis. They may equally be parallel.

In a further advantageous embodiment of the invention, one of the two light beams for the most part encounters the semi-transparent area and the other of the two light beams is for the most part transmitted directly by the module without encountering the area.

In a further advantageous embodiment of the invention, the module comprises a light guide, that light guide having a generally flat transversal cross section, an exit surface and a reflection surface configured to reflect toward the exit surface the light rays introduced into the light guide from an internal area of the guide.

In a further advantageous embodiment of the invention, the reflecting surface of the guide is a curved surface generated by straight line segments perpendicular to the longitudinal axis of the guide.

In another advantageous embodiment of the invention, the light guide comprises a plurality of longitudinally distributed internal areas for introduction of light.

The invention also provides a signaling device for automobile vehicles comprising a module of the invention, such as a parking light, a stop light or a turn indicator.

The invention has the advantage of proposing a signaling device that combines an interesting appearance with performance that is of benefit from the photometric point of view. This photometric performance enables the “parking light” and “stop” functions to be provided in a manner that is original and of benefit from a cost point of view, notably because of a limited lighting power. Moreover, the use of a light guide confers great freedom of design, improved homogeneity of lighting, and a commensurately more interesting appearance.

These and other objects and advantages of the invention will be apparent from the following description, the accompanying drawings and the appended claims.

### BRIEF DESCRIPTION OF THE ACCOMPANYING DRAWINGS

Other features and advantages of the present invention will be better understood in the light of the description and the drawings, in which:

FIG. 1 shows a signaling module of a first embodiment of the invention;

FIG. 2 is a view in horizontal longitudinal section of the light guide of the FIG. 1 signaling module;

FIG. 3 shows the image produced by the FIG. 1 signaling module;

FIG. 4 shows a signaling module of a second embodiment of the invention;

FIG. 5 shows a signaling module of a third embodiment of the invention; and

FIG. 6 shows a signaling module of a fourth embodiment of the invention

### DETAILED DESCRIPTION OF THE PREFERRED EMBODIMENTS

The various embodiments shown in the figures are intentionally simplified and diagrammatic, with the aim of clarifying the disclosure of the invention. In practice, the various components of the invention could have significantly more complex shapes, notably in relation to various constraints linked to dimensions.

In the following description, terms qualifying the position of some elements, such as “above”, “below”, “front”, “rear”, “in front of”, “behind”, “horizontal”, “vertical”, “upper”, “lower”, etc. relate to the specific arrangements of the figures. These terms are however not to be interpreted in a strict and absolute manner but rather in a relative manner. The signaling modules described may in practice be oriented differently without in any way departing from the scope of the invention.

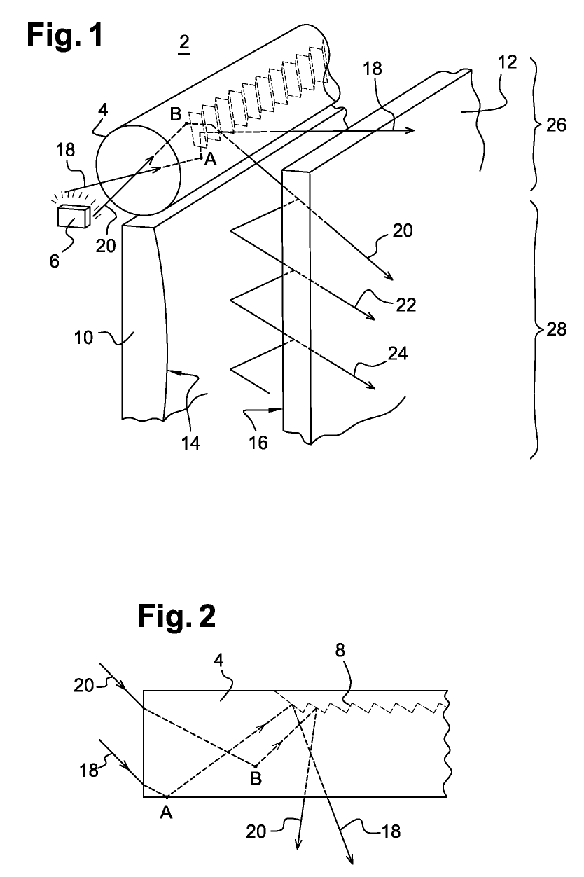

FIG. 1 shows a signaling module 2 conforming to a first embodiment of the invention. The signaling module 2 essentially comprises a light guide 4 extending longitudinally in a manner that is transverse to the general lighting or illumination direction, the latter being oriented horizontally from left to right. The signaling module 2 also comprises a screen 12 with a semi-transparent surface 16 disposed in front of the light guide 4 and a reflector 10 disposed below the light guide 4 and in front of the screen 12.

The light guide 4 is of generally circular section and comprises a series of facets 8 on the rear portion of its surface. These facets 8 form reflecting surfaces and are oriented in such a manner as to reflect transversely light rays propagating along the light guide 4, so that they leave the light guide 8 and propagate in the main illumination direction. These facets 8 are preferably covered with a reflecting coating. The light guide 4 is fed with light rays by one or more light sources 6, such as light-emitting diodes (LED), from one end.

When the light source or LED 6 is energized, it emits light rays essentially into a half-space directed toward the end of the light guide 4. Two light rays are represented in FIG. 1 and in FIG. 2 in such a manner as to illustrate the operating principle of the light guide 4 and the signaling module 2.

A first ray 18 in a generally horizontal plane enters the light guide 4 with refraction so as to reflected at a point A on the external surface of the light guide 4 in accordance with the principle of total reflection. The surface of the light guide 4 forms a diopter between the material of the light guide 4 having a given refractive index (typically of the order of 1.6 for polycarbonate) and the surrounding air, which has a different refractive index (equal to 1). This refractive index difference of two contiguous media has the consequence that there exists a limit angle of incidence beyond which refraction is impossible and at which total reflection occurs. In the case of a polycarbonate medium surrounded with air, this limit angle is of the order of 38° (according to the Snell-Descartes law). This first ray 18 will then be directed toward one of the reflecting facets 8 to be reflected there in a direction transverse to the longitudinal axis of the light guide 4, to encounter the surface of the light guide 4 at a low angle of incidence less than the limit angle of incidence (see above), and exit the light guide 4, possibly with slight refraction. This first ray 18 is in a generally horizontal plane and is propagated directly toward the space to be lit or illuminated, passing over the upper edge of the screen 12.

The ray 20 also emitted by the LED 6 is oriented in a direction having a vertical component. It enters the light guide 4 with slight refraction and is propagated to a point B on the surface of the light guide 4. In a similar way to the first ray 18, according to the principle of total reflection, the ray 20 will be reflected toward one of the reflecting facets 8. It will then be reflected at the facet and then directed toward the front surface of the light guide 2. In a similar way to the first ray 18, it will encounter the front surface of the light guide 2 with a very small angle of incidence and because of this leave the light guide 2 with slight refraction and be propagated toward the semi-reflecting surface 16 of the screen 12. As may be seen in FIG. 2, which is a view in section on a longitudinal horizontal plane, the ray 20 evolves similarly to the first ray 18 in a horizontal plane. As may be seen in FIG. 1, which is a perspective view, because of its inclination relative to the horizontal plane, the ray 20 leaving the LED 6 evolves in an inclined plane and is then reflected by the reflecting facet 8 toward a low portion of the front surface of the light guide 4.

It should be noted that the propagation of light rays along a light guide and the exit of these rays by means of reflecting facets notably of the prismatic type is well known in itself to the person skilled in the art.

The two rays 18 and 20 are two illustrative examples of the rays emitted by the LED 6 and transmitted by the light guide 4. The light emitted by the LED 6 and transmitted by the light guide 4 of course comprises a beam constituted of a multitude of light rays that travel along the light guide 4 undergoing a series of reflections to leave it in a manner that is homogeneous along its length. Some of the rays leaving it will leave the light guide 4 in a direction close to the main lighting direction and because of this pass over the semi-reflecting surface 16 of the screen 12. Others of the leaving rays will leave the light guide 4 in directions inclined downward relative to the main lighting direction and will thus encounter the semi-reflecting surface 16.

The rays encountering the semi-reflecting surface 16 of the screen 12, such as the ray 20, will be partially transmitted and partially reflected. The ray 20 representative of these rays is subject to partial reflection by the semi-reflecting surface 16. The reflected portion of the ray 20 is returned toward the screen 12 by the reflector 10 to be partially transmitted 22 and reflected again. This reflected portion 22 of the ray is sent back toward the screen 12 by the reflector 10 to be partially transmitted again, and so on. Consequently, some of the light rays encountering the semi-transparent portion, preferably more than 4% of the rays encountering this surface, are reflected toward the reflector by the screen 12. This reflected portion is then totally reflected or quasi-totally reflected toward the screen 12 by the reflecting surface 14 of the reflector 10. In a similar way to the previous rays, these rays will then be partially transmitted by the semi-transparent screen 12 and partially reflected again toward the reflector 10. This reflection and shifting toward the center of the cavity is assured by the domed nature of the reflector 10. It should be noted that the surface of the reflector 10 could alternatively be generally plane and the internal surface of the screen 12 delimiting the cavity would then be domed. Considering a combination of domed surfaces at the level of the screen 12 and the reflector 10 may equally be envisaged.

The screen 12 may be produced using a transparent material routinely used, such as certain plastics or glass, for example. One of its surfaces, the external or internal surface, is rendered semi-transparent by application of a coating that is typically partially reflecting. The coating is usually a metallic coating such as aluminum or a stainless metal applied by a vacuum vapor phase deposition technique. Various methods of application of the coating known to the person skilled in the art may be used. The reflection factor of the coating is in the range 20% to 60%, for example.

The rays being propagated directly toward the space to be lit or illuminated without encountering the semi-reflecting surface 16 will constitute a first lighting beam 26 that may correspond to a “stop” function. The rays encountering the semi-reflecting surface 16 will suffer losses on successive partial transmissions and may thus correspond to a signaling function of the “parking light” type. From a regulations point of view, the lighting power required for the “parking light” function is less than that required for the “stop” function, by a ratio in excess of ten (10). It follows that the module described above is particularly well suited to such an application.

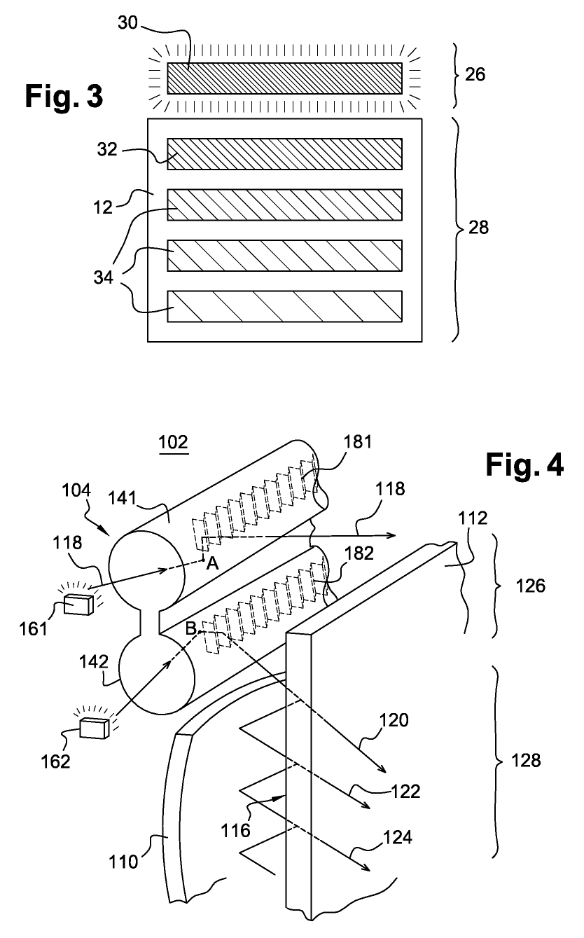

FIG. 3 shows the image produced by the FIG. 1 module. The upper portion 26 of the beam corresponds to rays transmitted directly without encountering the semi-reflecting surface. The image produced comprises a band 30 corresponding to the light guide 4. The multitude of reflecting facets of the light guide 4 ensures a certain level of homogeneity in the image produced. Notably as a function of the size of these facets, the image could have a greater or lesser homogeneity.

The lower portion 28 generates a three-dimensional effect. The image produced comprises a first band 32 essentially corresponding to the band 30 but with a lower power level because of losses inherent to transmission through the semi-reflecting surface. It also comprises a series of bands 34 corresponding to the initial band 32 that are repeated and become finer and finer, thus generating the 3D effect. The level of lighting power also decreases progressively because of losses linked to transmission through the semi-reflecting surface.

The LED or LEDs 6 are preferably of controlled current (PWD (Pulse Width Modulation)) type. The relation between the voltage and the supply current of the emissive semiconductors (the LEDs) is not linear. Thus a small increase of voltage applied to the LED 6 may lead to a high increase in the current and thus in the luminous flux emitted. The brightness of the LEDs 6 to be controlled necessitates a current that remains constant whatever the input voltage.

In practice, the two parts 26 and 28 of the light beam produced are always present when the light source is or the light sources are supplied with electrical current. As a function of the power supplied, the module in question could provide the “stop” and “parking light” functions. At a low power supply level, the portion 26 of the beam coming directly from the light guide 4, i.e. without undergoing partial reflection, will produce a first lighting level sufficient from a photometric point of view and a regulations point of view for the “parking light” function. At a higher level of supplied power, the portion 26 of the beam coming directly from the light guide 4 will produce a higher level of lighting corresponding from a photometric and regulations point of view to the requirements of the “stop” function. The three-dimensional part 28 will then produce a lighting level greater than for the “parking light” function alone. This lighting level alone will then be sufficient from a regulations point of view for the “parking light” function. The module described above thus enables a two-fold “stop” and “parking light” function to be offered with a three-dimensional effect without requiring too high a lighting power at the level of the light sources. This is essentially caused by the fact that a portion of the beam leaving the light guide 4 is propagated directly toward the space to be illuminated without suffering any loss. The construction of the module with the light guide 4 confers great freedom from a design point of view. The construction of the module is also particularly simple and of relatively low cost.

In the FIG. 1 configuration, the screen 12 is positioned in such a manner that its upper edge is approximately half way up the light guide 4, so that the upper part of the light beam leaving the guide is propagated directly toward the space to be illuminated without encountering it. The semi-reflecting surface 16 extends as far as the upper edge, thus forming a cut-off edge between the beams transmitted directly and partially reflected. It is to be noted that the screen 12 may comprise a transparent part and a semi-transparent part, the transparent part then being able to extend toward the upper part of the beam in such a manner as to have the rays of the upper portion 26 of the beam produced pass through it.

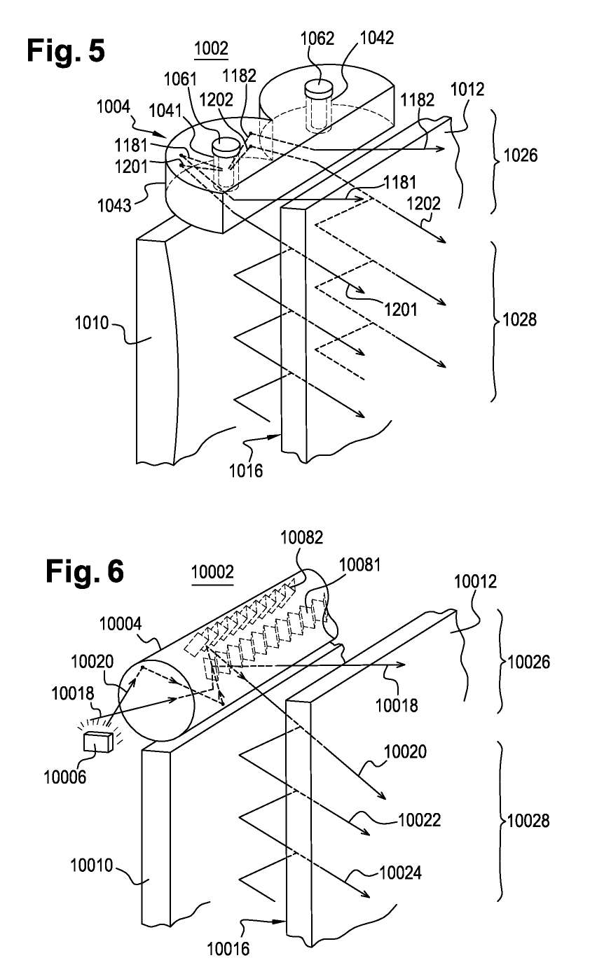

Other embodiments of the invention will be described with reference to FIGS. 4 to 6. These examples constitute variants of the FIG. 1 example. Numerous components of the modules shown in these figures correspond to those of FIG. 1. Consistent numbering has been adopted to designate these various components, the reference signs in FIG. 4 corresponding to those of FIG. 1 except that they are increased by 100. The same applies to FIG. 5, where they are increased by 1000, and FIG. 6, where they are increased by 10 000. Numbers specific to each embodiment have been employed to designate components not present in FIG. 1.

FIG. 4 shows a second embodiment of a signaling module of the invention. It is distinguished from the first embodiment essentially in that the radiating means 104 comprise two light guides 141 and 142 disposed parallel to each other and one above the other. Each of these light guides 141, 142 specifically comprises at one of its ends at least its own light source constituted of one or more LEDs 161 and 162. Each of these light guides 141, 142 also comprises a series of reflecting facets 181 and 182, in a similar way to the FIG. 1 light guide. These facets are disposed in such a manner as to reflect rays propagating along the light guides 141, 142 transversely toward the space to be illuminated.

The rays emitted by the LED 161 of the upper light guide 141 are propagated along the upper light guide 141 and are reflected homogeneously in a direction generally perpendicular to the longitudinal axis of the upper light guide 141. A ray 118 is represented in order to illustrate the principle of reflection. The upper light guide 141 and its reflecting facets 181 are configured in such a manner that most of the rays leaving the upper light guide 141 are oriented in the main illumination direction. These rays, like the first ray 18, are propagated directly toward the space to be illuminated without encountering the semi-reflecting surface 116 of the screen 112.

The phenomena described for the upper light guide 141 apply equally to the lower light guide 142. A ray 120 is represented in order to illustrate the phenomena of reflection in a similar way. Most of the rays leaving the lower light guide 142 encounter the semi-reflecting surface 116. These rays are then partially transmitted and partially reflected toward a reflector 110. The latter has a non-plane surface, for example a curved concave surface. The reflection-transmission of rays at the semi-reflecting surface 116 and the pure reflection at the reflector 110 generate a 3D effect in a similar way to the module of the first embodiment of the invention. More particularly, the ray 120 leaving the guide is partially transmitted by the screen 112 and partially reflected toward the reflector 110 so as thereafter to be partially transmitted by the screen as a ray 122 and partially reflected toward the reflector 110 so as thereafter to be again partially transmitted as a ray 124, and so on.

Thus the FIG. 4 module produces two independent beams, namely a first beam 126 the rays of which leaving the upper light guide 141 are propagated directly toward the space to be illuminated without encountering the semi-reflecting surface 116, and a second beam 128 passing through the semi-reflecting surface 116.

The first beam 126 may consequently correspond to a “stop” function and the second beam 128 to a “parking light” function. In this case, the light sources 161 and 162 are energized independently. Energizing the light source 162 of the second beam 128 will then provide the “parking light” function with a 3D effect and energizing the light source 161 of the first beam 126 will provide the “stop” function. The “stop” function could thus have no three-dimensional effect. It should nevertheless be noted that it is possible to provide for coupled energization in order for the three-dimensional effect to be present in both functions.

FIG. 5 shows a third embodiment of a signaling module of the invention. It is similar to the first embodiment but with a major difference being the type of light guide. The light guide of the first embodiment (FIG. 1) is of generally circular section and propagates the light along its longitudinal axis. In the case of FIG. 5, the light guide 1004 is different to the degree that it receives light from an internal area and not from one end. More particularly, the light guide 1004 comprises a series of orifices or wells 1041, 1042 distributed over its length. A light source 1061, 1062 is disposed in or near each orifice 1041, 1042. The rays emitted by one of the light sources 1061 in lateral directions relative to the main lighting direction and rear directions are reflected by a reflecting surface 1043 of the light guide 1004 in a direction generally aligned with the main lighting direction. This surface is generally defined by generatrices perpendicular to the longitudinal axis of the light guide 1004. It has a curved profile in such a manner as to be able to assure reflection of most of the rays propagating in a sector of more than 180°, this sector being essentially oriented toward the rear. These rays are reflected in such a manner as to encounter the exit surface substantially perpendicularly. The surface 1043 consequently has a succession of curved profiles, each of these profiles extending around a light source. The light guide 1004 is of generally straight cross section. The exit face of the light guide 1004 also has a generally straight cross section.

The operating principles and the structural details of such a light guide are well known in themselves to the person skilled in the art, notably from the patent document EP 1 881 263 A1, which was also published as U.S. Patent Publications 2008/0019139, 2010/0238675 and 2012/0075876 and also as U.S. Pat. Nos. 7,731,400 and 8,070,336, all of which are incorporated herein by reference and made a part hereof.

In a similar way to the first embodiment of the invention (FIG. 1), some of the rays emitted by the light guide essentially in the main illumination direction are propagated directly toward the space to be illuminated without encountering the semi-reflecting surface 1016 and others of these rays encounter the semi-reflecting surface 1016. Four rays are represented in order to show clearly the phenomena of light propagation. A first ray 1181 is emitted by the light source 1061 in a lateral direction of the module and directed slightly upward. This ray encounters the reflecting surfaces 1043 at a given point situated in an upper half of the surface. The ray is reflected toward the exit surface with a low angle of incidence. The ray exits the surface with little or no refraction and passes above the upper edge of the semi-reflecting surface 1016 to be propagated directly toward the space to be illuminated. The same goes for the second ray 1182 emitted by the same light source in a direction globally opposite that of the first ray 1181 and also directed slightly upward. This first ray 1181 is reflected by the reflecting surface 1043, exits the light guide 1004 and is propagated directly toward the space to be illuminated. The third ray 1201 is emitted in a direction close to that of the first ray 1181 but inclined slightly downward. This third ray 1201 will be reflected by the reflecting surface 1043 in a similar way to the first ray 1181 in a direction inclined slightly downward. On exiting the light guide 1004 with this inclination, the third ray 1201 will encounter the semi-reflecting surface 1016 and be subjected to a combination of partial transmission and partial reflection by the reflector 1010 in a similar way to the modules of FIGS. 1 and 4.

Because of its enveloping shape and the profile chosen for it, the reflecting surface 1043 has the capability to “recover” by reflection most of the rays emitted by the light source and being propagated in the light guide 1004 in a radial manner within a sector of more than 180°, preferably a sector greater than 220°, even more preferably a sector greater than 270°, generally directed toward the rear.

Some of the rays exiting the waveguide will consequently be propagated directly toward the space to be illuminated without encountering the semi-transparent surface and some other rays will be subjected to a combination of partial transmission and partial reflection, thereby generating a three-dimensional image of lesser photometric power. Given the similarity of the modules from FIGS. 5 and 1, the remarks made in relation to FIG. 1 in relation to the “stop” and “parking light” functions and the energization of the light sources apply equally to FIG. 5.

FIG. 6 shows a fourth embodiment of a signaling module of the invention. It is notably similar to that of FIG. 1 with the main difference that the light guide comprises a second row of reflecting facets so as to reflect some of the rays being propagated in the guide in a direction inclined downward. The light guide 10004 from FIG. 6 is similar to that from FIG. 1. It is of generally circular section and comprises a first row of reflecting facets 10081 comparable to the row of facets 8 from FIG. 1. It further comprises a second row of reflecting facets 10082 offset angularly relative to the first row of reflecting facets 10081. The first row of reflecting facets 10081 reflects some of the rays being propagated along the light guide 10004, in a direction generally transverse, preferably perpendicular, to the longitudinal axis of the light guide 10004 and generally aligned with the main illumination direction. The second row of reflecting facets 10082 is disposed parallel to the first row of reflecting facets 10081, in an angular position offset in such a manner as to reflect other rays being propagated along the light guide 10004, in a direction generally transverse, preferably perpendicular, to the longitudinal axis of the light guide 10004 and inclined relative to the main illumination direction. These rays reflected by the second row of reflecting facets 10082 encounter the semi-transparent surface 10016 of the screen 10012. These rays are subject to a successive combination of transmission and partial reflection by the screen 10112 and pure reflection by the reflector 10010.

Two rays 10018 and 10020 are represented in order to illustrate the principles of light propagation and reflection. The first ray 10018 is comparable to the first ray 18 from FIG. 1. It is emitted by the LED 10006 in a generally horizontal plane. It encounters the surface of the light guide 10004 and is there subjected to reflection based on the principle of total reflection thereafter to encounter a reflecting facet 10081 and to be reflected there in a direction generally perpendicular to the longitudinal axis of the light guide 10004. The first ray 10018 remains approximately in the horizontal plane and exits the light guide 10004, being propagated along the main lighting direction directly toward the space to be illuminated without encountering the semi-transparent surface. The second ray 10020 emitted by the LED 10006 is inclined upward and is subjected to two successive reflections at the surface of the waveguide, based on the principle of total reflection. It then encounters a reflecting facet 10082 of the second row. The angle of this facet to the first row of reflecting facets 10081 has the effect of diverting the ray 10020 slightly downward and therefore toward the semi-reflecting surface 10016 of the screen 10012. There then follows a succession of partial reflections/transmissions by the semi-reflecting surface 10016 and total reflections by the reflector 10010. The latter is inclined relative to the semi-reflecting surface in such a manner as to influence the interaction with the surface and to generate a three-dimensional effect. It could equally be domed in a concave or convex manner as in the modules of FIGS. 1 and 4.

In a similar way to the remarks made for the FIG. 1 example, the upper portion 10026 of the beam coming from the first row of reflecting facets 10081 without being subjected to partial transmission enables the assurance of a lighting power conforming to the photometric requirements for the “stop” function. The lower portion 10028 of the beam coming from the second row of facets 10082 produces an image with a three-dimensional effect of lower lighting power, notably for the “parking light” function in combination with the “stop” function. The “parking light” function could be assured by the two portions 10026 and 10028 if the light source or sources is or are supplied with a lower power.

While the system and apparatus herein described constitute preferred embodiments of this invention, it is to be understood that the invention is not limited to this precise system and apparatus, and that changes may be made therein without departing from the scope of the invention which is defined in the appended claims.

What is claimed is:

1. A luminous signaling module, notably for automobile vehicles, comprising:
a reflector with a reflecting surface;
a screen disposed in front of said reflector, said screen comprising a semi-reflecting area;
radiating means adapted to emit light rays,
said reflector, said screen and said radiating means being arranged in such a manner that a first portion of said rays emitted by said radiating means encounters said semi-reflecting area, some of said rays of said first portion being transmitted directly through said semi-reflecting area, other rays of said first portion being reflected by said semi-reflecting area toward said reflector that sends them back again toward said semi-reflecting area, in such a manner as to generate a repetitive visual effect of depth;
wherein said semi-reflecting area is configured and arranged relative to said radiating means in such a manner that a second portion of said rays emitted by said radiating means does not encounter a semi-transparent area.

2. The luminous signaling module according to claim 1, wherein said screen forms with said reflector a space in which reflected rays are propagated, said space being delimited by a surface of said screen and a reflecting surface of said reflector, at least one of said surfaces being such that rays reflected by said semi-reflecting area from a first location of this area encounter this area again, after reflection at said reflector, at a second location distinct from said first location.

3. The luminous signaling module according to claim 1, wherein said screen forms with said reflector a space in which reflected rays are propagated, this space being delimited by a surface of said screen and a reflecting surface of said reflector, at least one of these surfaces being domed.

4. The luminous signaling module according to claim 1, wherein said radiating means comprise a light source and at least one element for diverting rays emitted by said light source.

5. The luminous signaling module according to claim 4, wherein said at least one element for diverting rays comprises at least one light guide, notably a longitudinal light guide.

6. The luminous signaling module according to claim 5, wherein said light guide is configured to reflect generally transversely to its longitudinal axis light rays traveling through said light guide in such a manner as to form light rays emitted by said radiating means.

7. The luminous signaling module according to claim 5, wherein said light guide is disposed along one edge of said reflector.

8. The luminous signaling module according to claim 5, wherein said radiating means are configured so that said light guide is fed with light exclusively at one at least of its ends.

9. The luminous signaling module according to claim 5, wherein said light guide comprises on its exterior surface, preferably on a portion that is opposite said screen, a first row of reflecting facets adapted to reflect generally transversely in a first direction.

10. The luminous signaling module according claim 1, wherein said radiating means emit light rays in only one main direction and said semi-transparent area of said screen is disposed in such a manner that one of its edges is a frontier between said first portion and said second portion of said light rays.

11. The luminous signaling module according to claim 9, characterized in that the light guide comprises on its exterior surface a second row of reflecting facets adapted to reflect light trays traveling through it in a second direction inclined relative to the first direction in such a manner that the rays emitted are directed toward said semi-transparent area.

12. The luminous signaling module according to claim 1, wherein said radiating means comprises two light guides, for example longitudinal light guides, configured to reflect light rays traveling through them in such a manner as to form two beams of parallel light rays in a main illumination direction.

13. The luminous signaling module according to claim 12, wherein one of said two beams of parallel light rays for the most part encounters said semi-transparent area and the other of said two beams of parallel light rays is for the most part transmitted directly by said luminous signaling module without encountering said semi-transparent area.

14. The luminous signaling module according to claim 1, wherein it comprises a light guide said light guide having a generally flat transversal cross section, an exit surface and a reflection surface configured to reflect toward said exit surface said light rays introduced into said light guide from an internal area of said light guide.

15. A signaling device for automobile vehicles comprising a module according to claim 1.

16. A luminous signaling module for automobile vehicles, comprising:
a reflector having a reflecting surface;
a screen disposed in front of said reflector, said screen comprising a semi-reflecting area;
a radiator adapted to emit light rays,
said reflector, said screen and said radiator being arranged in such a manner that a first portion of said rays emitted by said radiator encounters said semi-reflecting area, some of said rays of said first portion being transmitted directly through said semi-reflecting area, other rays of said first portion being reflected by said semi-reflecting area toward said reflector that sends them back again toward said semi-reflecting area, in such a manner as to generate a repetitive visual effect of depth;
wherein said semi-reflecting area is configured and arranged relative to said radiator in such a manner that a second portion of said rays emitted by said radiator does not encounter a semi-transparent area.

17. The luminous signaling module according to claim 16, wherein said screen forms with said reflector a space in which reflected rays are propagated, said space being delimited by a surface of said screen and a reflecting surface of said reflector, at least one of said surfaces being such that rays reflected by said semi-reflecting area from a first location of this area encounter this area again, after reflection at said reflector, at a second location distinct from said first location.

18. The luminous signaling module according to claim 16, wherein said screen forms with said reflector a space in which reflected rays are propagated, this space being delimited by a surface of said screen and a reflecting surface of said reflector, at least one of these surfaces being domed.

19. The luminous signaling module according to claim 16, wherein said radiator comprise a light source and at least one element for diverting rays emitted by said light source.

20. The luminous signaling module according to claim 19, wherein said at least one element for diverting rays comprises at least one light guide, notably a longitudinal light guide.
